(19) United States
(12) Patent Application Publication
(10) Pub. No.: US 2022/0175149 A1
(43) Pub. Date: Jun. 9, 2022

(54) THERAPEUTIC CUSHION SYSTEMS AND METHODS

(71) Applicant: Amenity Health, Inc., San Diego, CA (US)

(72) Inventors: Aaron CLARK, San Diego, CA (US); Clint ERICKSON, San Diego, CA (US)

(73) Assignee: Amenity Health, Inc., San Diego, CA (US)

(21) Appl. No.: 17/682,901

(22) Filed: Feb. 28, 2022

Related U.S. Application Data
(62) Division of application No. 15/991,414, filed on May 29, 2018.
(60) Provisional application No. 62/512,371, filed on May 30, 2017.

(51) Int. Cl. A47C 20/02; A47G 9/10; A61G 7/07

(52) U.S. Cl. CPC A47C 20/027; A47C 20/026; A47C 27/142; A61G 7/07; A47G 9/1072; A47G 9/1081

(57) ABSTRACT

An apparatus includes a therapeutic cushion including a body support portion, a head support portion and a back support portion. The body support portion has a first end portion and a second end portion and a top surface disposed at an angle relative to a bottom surface. The second end portion has a height greater than a height of the first end portion. The body support portion and the head support portion collectively define a receiving portion configured to receive a user's arm therein and is asymmetric relative to a centerline of the apparatus. The back support is disposed on a portion of the top surface of the body support portion. The back support is configured to maintain the user in a side position on the therapeutic cushion.

### CROSS-REFERENCE TO RELATED APPLICATIONS

This application is a divisional of U.S. application Ser. No. 15/991,414, entitled “Therapeutic Cushion Systems and Methods,” filed May 29, 2018, which claims priority to and the benefit of U.S. Provisional Application No. 62/512,371, entitled “Therapeutic Cushion Systems and Methods,” filed May 30, 2017, each of the disclosures of which are incorporated herein by reference their entirety.

This application is also related to U.S. patent application Ser. No. 14/820,832, entitled “Therapeutic Cushion Systems and Methods”, now U.S. Pat. No. 10,349,752, filed Aug. 7, 2015, the disclosure of which is incorporated herein by reference in its entirety.

### BACKGROUND

Some embodiments described herein relate to therapeutic cushion systems and methods, and in particular, to therapeutic cushion systems and methods for use in the treatment of various medical conditions, such as, for example, gastro-esophageal reflux disease.

Gastro-esophageal reflux disease (GERD) is a medical term that describes a malady in which acid-laden, partially digested stomach contents reflux—i.e., flow in an abnormal backward fashion—from the stomach into the esophagus. Reflux of gastric contents into the esophagus is most common, and does the most damage, when the GERD sufferer is sleeping and unaware that the reflux is occurring.

Some known systems use pillows or other supportive apparatuses to effectively manage or control symptoms of conditions that otherwise would have required a medical prescription or surgery to alleviate. For example, some known pillow options include an elevated pillow with a protrusion within the pillow focused on the cervical region of the neck, which is intended to provide comfort or better resting conditions for individuals suffering from cardiac conditions, emphysema or other respiratory difficulties. Such a pillow does not allow for an extended support below the sacrum region of the spine; nor does the pillow provide for any comfortable position other than supine.

Some known devices include an orthopedic pillow that can be used to minimize snoring in an individual. While such a pillow can be used to address conditions such as snoring, such a pillow may not be configured to treat conditions such as GERD. In fact, such an orthopedic pillow typically only provides an elevation component and fails to address any other component that may be desired for the relief of symptoms of a GERD sufferer.

Another known system includes a support pillow including a body with a central section and two wings for use in controlling symptoms associated with head and neck hyperextension, which is often seen in infants with bronchopulmonary dysplasia, or other related conditions. Another known system includes an apparatus that can be used to prevent positional plagiocephaly in an infant by distributing loads otherwise borne by the head of the infant across a horizontal surface. While these systems may provide a benefit to infants, their specific design and structural engineering is based on the user of the pillow being an infant. Such pillows are not disclosed as providing a benefit for an adult or adolescent user suffering from GERD.

Most of the above described known systems focus on conditions relating to infants and/or the head-only region, without regard to addressing support of, or interaction with, the entire body. Other known systems include a pillow meant to accommodate an adult person (as a general body pillow) or an infant (to assist in supporting the infant in a seated position). Such systems, however, do not contemplate use of the pillow to alleviate symptoms relating to gastric or esophageal disorders. Additionally, such a pillow may not accommodate the necessary features specific for controlling or managing such disorders. Another known system includes a large, contoured body pillow to facilitate relief from persistent back and neck pain, and/or respiratory and digestive disorders; however, the bulk of such a pillow is typically in excess of what is practical for use by a normal individual in a bed.

Thus, a need exists for therapeutic cushion systems and methods that can address the shortcomings of the known pillow systems identified above, and that can be used to manage and/or control symptoms associated with GERD and/or other medical conditions, while maintaining a practical, accommodating fit for the user.

### SUMMARY

Apparatus and methods are described herein for a therapeutic cushion that can be used to treat symptoms associated with GERD and/or other digestive disorders and/or other medical conditions, and can be used during a procedure, such as an endoscopy procedure to maintain a patient in a desired position. In some embodiments, an apparatus includes a therapeutic cushion including a body support portion, a head support portion and a back support portion. The body support portion has a first end portion and a second end portion and a top surface disposed at an angle relative to a bottom surface. The second end portion has a height greater than a height of the first end portion. The body support portion and the head support portion collectively define a receiving portion configured to receive a user's arm therein and is asymmetric relative to a centerline of the apparatus. The back support is disposed on a portion of the top surface of the body support portion. The back support is configured to maintain the user in a side position on the therapeutic cushion.

### BRIEF DESCRIPTION OF THE DRAWINGS

FIG. 1 is a schematic illustration of a therapeutic cushion, according to an embodiment.

FIG. 2 is a perspective view of a therapeutic cushion, according to an embodiment.

FIG. 3 is a top view of the therapeutic cushion of FIG. 2.

FIG. 4 is a bottom view of the therapeutic cushion of FIG. 2.

FIG. 5 is a right side view of the therapeutic cushion of FIG. 2.

FIG. 6 is a left side view of the therapeutic cushion of FIG. 2.

FIG. 7 is a head end view of the therapeutic cushion of FIG. 2.

FIG. 8 is a foot end view of the therapeutic cushion of FIG. 2.

FIG. 9 is a side perspective view of the therapeutic cushion of FIG. 2, shown with a pillow disposed thereon.

FIG. 10A is a top view of the therapeutic cushion and pillow of FIG. 9 shown with the therapeutic cushion disposed on a support and a user disposed on the therapeutic cushion.

FIG. 10B is a side view of the therapeutic cushion and pillow of FIG. 10 shown with the therapeutic cushion disposed on a support and a user disposed on the therapeutic cushion.

FIG. 11 is a top view of the therapeutic cushion of FIG. 2-10B illustrating example zones for placement of a user's arm/hand and head during use of the therapeutic cushion.

FIG. 12 is a perspective view of a therapeutic cushion, according to another embodiment.

FIG. 13 is a top view of the therapeutic cushion of FIG. 12.

FIG. 14 is a left side view of the therapeutic cushion of FIG. 12.

FIG. 15 is a perspective view of the therapeutic cushion according to another embodiment.

FIG. 16 is a top view of the therapeutic cushion of FIG. 15.

FIG. 17 is a bottom view of the therapeutic cushion of FIG. 15.

FIG. 18 is a left side view of the therapeutic cushion of FIG. 15.

FIG. 19 is a right side view of the therapeutic cushion of FIG. 15.

### DETAILED DESCRIPTION

Apparatus and methods for providing therapeutic treatment for symptoms associated with GERD and/or other digestive disorders and/or other medical conditions or ailments are described herein. In some embodiments, a therapeutic cushion system as described herein can allow the user to sleep comfortably for an extended period of time in a substantially flat or an inclined right-side lateral decubitus (RLD) position, or a substantially flat or an inclined left-side lateral decubitus (LLD) position. In the inclined RLD position or the inclined LLD position, the therapeutic cushion system can serve to minimize, or eliminate, gastro-esophageal reflux. For example, the inclined RLD position can facilitate the emptying of the stomach into the duodenum, and the inclined LLD position can facilitate the reduction of reflux episodes.

In some embodiments, apparatus and methods are described herein for use during an endoscopy, which is a procedure in which a gastroenterologist uses a thin, flexible tube and camera system called an endoscope to examine the lining of the esophagus and stomach via a video monitor. The endoscope is inserted through the patient's mouth. To ensure the upper gastrointestinal tract is in alignment and to ease tube insertion, the patient is positioned on a stretcher or procedure table on their left side with their head elevated. The elevated and left-side-down orientation allows the endoscope to slide down and into the stomach from the top and prevents pulmonary aspiration. Apparatus are described herein that can accommodate this position by inclining the patient between about 15-20° by supporting the torso and stabilizing the patient on their side on the apparatus. The patient's downside arm can be inserted into an opening in the apparatus (e.g., also referred to herein as a receiving portion) and the patient's back can lean against a back (or side) bolster of the apparatus. The apparatus includes an asymmetrical, single-side use design such that it can be supported on an average endoscopy stretcher having a width of, e.g., about 26 inches. The arm opening (also referred to herein as “receiving portion”) can be sized to accommodate a blood pressure cuff typically on the patient's downside arm. In such a use, a downside arm opening is not necessary on the opposite side. The apparatus can include an asymmetric shape of the overall cushion and/or an asymmetric shape and extent of the receiving portion. As described herein, the asymmetric cushion can provide one side that provides for additional space and surface area on a support surface to position a user's arm/hand during an endoscopy procedure. The cushion can also provide an opposite side that provides additional surface area on the head support portion of the cushion to provide for positioning of a user's head to accommodate the orientation and position needed to perform an endoscopy procedure on the patient while lying on the cushion.

Apparatus described herein can include various lengths and widths and can include an inclined or angled support portion that is disposed at various angles to accommodate different needs and uses of a user. For example, in some embodiments, an apparatus can include an angled support portion that has a top surface disposed at an angle between about 6 degrees and about 30 degrees relative to a bottom surface.

An apparatus (e.g., therapeutic cushion) described herein can include an angled support portion that provides an angled support surface that can have a height at a first end that can be, for example, up to 2 inches, and a height at an opposite end that can be between, for example, about 4 inches and 14 inches. The support portion can have a length that can be, for example, between about 20 inches and 40 inches. In some embodiments, an apparatus has a length that can promote an appropriate torso angle for a user to comfortably maintain a lateral decubitus position on the apparatus during use. In some embodiments, an apparatus can have a bed length that can be supported on a bed and have substantially the same length as a bed. In some embodiments, an apparatus can have a bed length in the range of 24-39 inches. In one example, the overall width of the apparatus can be about 30 inches.

In some embodiments, a method of treating symptoms associated with gastro-esophageal reflux disease (GERD) can include positioning a user's body on an apparatus described herein (e.g., a therapeutic cushion) such that the user is disposed on the therapeutic cushion in an inclined right-side lateral decubitus (RLD) position or inclined left-side lateral decubitus (LLD) position such that the user's pyloric sphincter is disposed at an elevation lower than an elevation of the user's esophageal sphincter. For example, the user can be disposed on a support element or portion (or a base support as described herein) of a therapeutic cushion having an inclined top surface of between 6 degrees and 30 degrees. In such an embodiment, the user can be positioned on the support element (or base support) at an angle between about 5 and 20 degrees depending on factors, such as, for example, the density and/or deflection properties of the support element, and/or the weight of the user. The user's right arm or left arm can be positioned within a receiving portion of the therapeutic cushion defined between the support portion and a riser portion of the therapeutic cushion. The user of the therapeutic cushion can be maintained in the inclined RLD position or LLD position for a sufficient time period to treat symptoms associated with GERD. In some embodiments, the time period is at least one hour. In some embodiments, the time period is 6 hours.

In some embodiments, an apparatus includes a therapeutic cushion including a body support portion, a head support portion and a back support portion. The body support portion has a first end portion and a second end portion and a top surface disposed at an angle relative to a bottom surface. The second end portion has a height greater than a height of the first end portion. The body support portion and the head support portion collectively define a receiving portion configured to receive a user's arm therein and is asymmetric relative to a centerline of the apparatus. The back support is disposed on a portion of the top surface of the body support portion. The back support is configured to maintain the user in a side position on the therapeutic cushion.

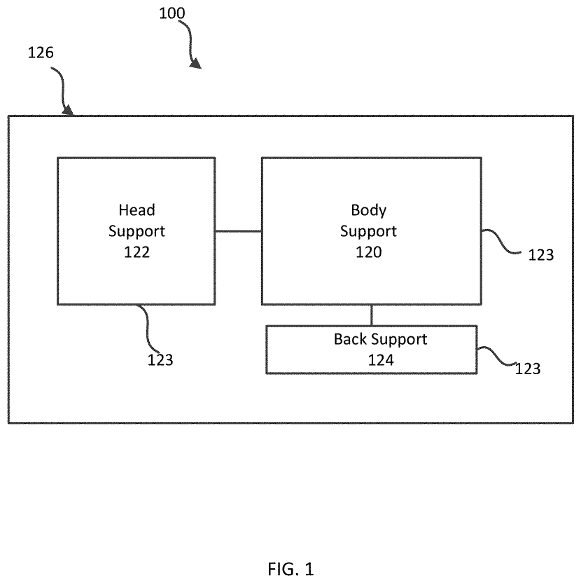

FIG. 1 is a schematic illustration of a therapeutic cushion according to an embodiment. A therapeutic cushion (also referred to herein as “cushion” or “apparatus”) 100 includes a body support portion 120 (also referred to herein as “wedge support” or “wedge portion” or “support portion”), a head support portion 122 (also referred to herein as “head support” or “head portion”) and a back support portion 128 (also referred to herein as a “back support”). As described above, the cushion 100 can be used, for example, for the treatment of symptoms associated with GERD and/or other digestive disorders and/or other medical conditions. For example, the cushion system 100 can allow the user to sleep for an extended period of time in an inclined right-side lateral decubitus (RLD) position (as described in more detail below), which can minimize, or eliminate, gastro-esophageal reflux while facilitating the emptying of the stomach into the duodenum, or an inclined left-side lateral decubitus (LLD) position, which can facilitate the reduction of reflux episodes. The cushion 100 can also be used during an endoscopy procedure to help maintain a patient in a desired position and orientation during the procedure.

The body support portion 120 can be substantially wedge shaped and have a height dimension that varies from a caudad end portion (also referred to herein as “first end portion”) of the support portion 120 to a cephalad end portion (also referred to herein as “second end portion”) of the support portion 120 (e.g., nearest the user's head), with the greatest height dimension being, for example, on the cephalad end portion of the support portion 120. The support portion 120 can optionally include a concave or indented portion (not shown) disposed on the top surface of the support portion 120, for example, at or near the cephalad end as described in U.S. patent application Ser. No. 14/820,832 (“the '832 application”) incorporated by reference above. The concave portion can be used, for example, to relieve pressure in the user's downside axilla when the user is lying in a lateral decubitus position on the cushion system 100.

The support portion 120 can also have a shape that can promote an appropriate torso angle for a user to comfortably maintain a lateral decubitus position on the support portion 120 during use. For example, the support portion 120 can optionally include a curved exterior portion that can help increase the comfort of a user lying in a lateral decubitus position for an extended period of time without uncomfortable pressure or pain in a downside shoulder or arm. In some embodiments, the support portion 120 can include beveled corners on the cephalad end of the support element 120 that can accommodate additional ergonomic arm and elbow placement during use of the cushion system 100.

The support portion 120 can be a variety of different lengths, widths and/or thicknesses. For example, in some embodiments, the support portion 120 can have a length that is shorter than a typical sized bed, such that the user's legs extend at least partially off the support portion 120 during use. Such a support portion 120 can be referred to as having a torso length. In some embodiments, the support portion 120 can be the length of a typical bed and can be referred to herein as having a bed length.

The head support portion 122 can be incorporated with the support portion 120 or can be fixedly or permanently coupled to the body support portion 120. The head support portion 122 is disposed near or proximate to the second end portion (i.e., cephalad end portion) of the body support portion 120 and can be used to support a neck and head of a user. A receiving portion (not shown in FIG. 1) is defined between the head support portion 122 and the body support portion 120 which can receive a portion of a user's arm therein as described in more detail below. The body support portion 120 and the head support portion 122 can also collectively define a lower arm/elbow relief cavity (also referred to herein as “cavity” or “relief cavity”) (not shown) open to or in fluid communication with the receiving portion and in which can receive a portion of a user's arm and/or hand therethrough. For example, when a user places an arm within the receiving portion, the user can extend a hand and/or a portion of the user's arm out through the relief cavity.

The body support portion 120 and the head support portion 122 can collectively define a shape of the therapeutic cushion 100, such that the therapeutic cushion 100 has a first side edge that is substantially linear along a length of the therapeutic cushion 100 and an opposite side edge that includes a curved or radiused portion adjacent or proximate the head support portion 122. Thus, the overall shape of the cushion 100 can be asymmetric as shown and described below with reference to specific embodiments.

The back support portion 128 can be incorporated with the support portion 120 or can be fixedly or permanently coupled to the body support portion 120. The back support portion 128 can be disposed on either a left side or right side of the body support portion 120 as described in more detail below with reference to specific embodiments. During use of the cushion 100, a user can lean their back against the back support 128 to maintain the user in a side position.

The body support portion 120, the head support portion 122 and the back support 128 can each include a separate cushion member coupled together or can be formed as a single cushion member 123. The cushion member(s) 123 can be formed with one or more foam materials, such as, for example, polyurethane or rubber latex, or visco-elastic polyurethane (e.g., memory foam). For example, in some embodiments, multiple components can be adhesively bonded together to form a single component for the cushion member(s) 123. In some embodiments, the cushion member(s) 123 can include multiple different foam materials each having a different density and/or a different deflection property. In alternative embodiments, the cushion member(s) 123 can include one or more inflatable chambers. In other alternative embodiments, the cushion member(s) can include a filler material, such as a polyester material, disposed within an inner casing. In some embodiments, the body support portion 120 and/or the head support portion 122 can include multiple cushion members 123 that can be, for example, stacked together. In some embodiments, the cushion member(s) 123 of the body support portion 120 can be formed with the same material(s) (e.g., foam) as the material(s) used to form the head support portion 122 and/or the back support portion 128. In some embodiments, different material(s) are used for the cushion member 123 of the body support portion 120, the cushion member 123 of the head support portion 122 and/or the back support portion 128.

The cushion member(s) 123 can be encased within a single outer casing 126. The outer casing 126 can be formed with one or more materials. In some embodiments, the outer casing 126 can be constructed of a two-way stretch material, such as, for example, jersey or interlock, or a velour fabric. In some embodiments, the outer casing 126 can include a top portion, which the user contacts during use of the therapeutic cushion 100 that is formed with a first material, and a bottom portion that contacts the support surface (e.g., top surface of a bed) on which the cushion 100 is disposed during use that is formed with a second material. In some embodiments, the top portion (e.g., the top surface) of the outer casing 126 can be formed with, for example, a four-way stretch material that is highly conformable, such as, for example, cotton/spandex, nylon/spandex, polyester/spandex or blends of any blend of cotton, nylon or polyester combined with spandex or elastane, and the bottom portion can be formed with a more robust material, such as, for example, poplin, canvas, gabardine or twill made using any combination of cotton, polyester or nylon, to provide durability. In some embodiments, the outer casing 126 can include a two-way or four-way stretch material on an outer surface with an impermeable undercover or sub-layer (i.e., an inside surface) to protect the interior cushion member from liquid absorption.

The outer casing 126 can include an opening through which the cushion member(s) 123 of the body support portion 120, the head support portion 122 and back support portion 128 can be inserted, and can include a fastener such as, for example, a zipper, buttons, snaps, flaps, hook and loop fasteners or other suitable coupling method to close or partially close the opening.

The receiving portion defined between the head support portion 122 and the body support portion 120 can be, for example, an opening, void, cavity, pocket, space or gap, etc. between the support portion 120 and the head support portion 122, in which a user can insert at least a portion of the user's arm. The receiving portion can define a variety of different shapes when viewed, for example, from a top view, and can be symmetric or asymmetric. For example, in some embodiments, the receiving portion extends from a centerline of the cushion 100 outward symmetrically in left and right lateral directions, and in other embodiments, the receiving portion extends asymmetrically from a centerline of the cushion 100 outwardly in left and right lateral directions.

During use of the cushion 100, a user can place a downside shoulder and arm within the receiving portion when lying in a side position. Insertion of the user's arm within the receiving portion between the body support portion 120 and the head support portion 122 can also mitigate the tendency of the user from sliding downward on the angled top surface of the support portion 120 and can help stabilize the user in the lateral or side position during use of the cushion 100.

In some embodiments, the head support portion 122 can include a pillow insert (not shown) alternative to or in addition to the cushion member 123 that can be disposed within the outer casing 126. The pillow insert can include an inner casing that can contain a filler material therein. The filler material can be, for example, a clustered polyester fiber material, such as, for example, any combination of polyester fibers, clustered polyester fiber, down alternative made from synthetic fibers, polystyrene beads/pellets, shredded foam, or down feathers. The inner casing of the pillow insert can also be formed with a four-way stretch material as described above for the outer casing 126. The inner casing of the pillow insert can also include an opening through which the filler material can be inserted, and can include a fastener such as, for example, a zipper, buttons, snaps, or other suitable coupling method to close or partially close the opening. In alternative embodiments, the inner casing may not include such an opening. For example, after the filler material has been inserted into the inner casing, the inner casing can be closed with, for example, stitching.

In some embodiments having a casing 126 formed with a four-way stretch material in conjunction with a pillow insert having an inner casing formed with the four-way stretch material and having a clustered polyester fiber filler material can allow the head support portion 122 to be malleable and shape-retaining. For example, in such an embodiment, the user can conform the head support 122 to a desired thickness and/or shape for that user's needs and preference. For example, the user can conform or adjust the head support 122 to form cavities or to otherwise fit or conform to the user's face, ear, arm, etc. The conformed shape can be maintained for an extended time period and/or until the user disperses the filler material of the pillow insert by, for example, removing the pillow insert and shaking or fluffing it to reshape the filler material.

In some embodiments, the cushion 100 can be used together with a body element (not shown) as described in the '832 application incorporated by reference above. The body element (e.g., body element 124, 224, etc. described in the '832 application) can optionally be used to further help maintain a user in a desired position on the cushion 100. The cushion 100 can also be used together with a pillow (not shown in FIG. 1) placed on the head support portion 122.

To use the cushion 100, the cushion 100 can be placed on a support surface (e.g., a top surface of a bed or surgical table) and the user can then lie on the cushion 100 in a RLD or LLD position with user's head on the head support portion 122 and the user's torso at least partially on the body support portion 120. In some instances, it may be desirable for the user to be aligned in approximately a center portion of the body support portion 120 with the user's head positioned on the head support portion 122. The user can insert the user's right or left arm within the receiving portion formed between the body support portion 120 and the head support portion 122. Optionally, in some embodiments, the user can adjust the position of the user's right or left arm and shoulder within the receiving portion, such that user's downside axilla rests within a centered concave portion of the body support portion 120.

With the user's arm within the receiving portion, the cushion system 100 can maintain the user in the inclined RLD or LLD position. Thus, the tendency of the user to slide down the angled portion of the body support portion 120 can be reduced or eliminated.

As described above, the cushion 100 can be used as a method of treatment for GERD and/or other digestive disorders. To use the cushion 100 for this purpose, the user can follow the steps described above for being positioned on the cushion 100 in an inclined RLD position or an inclined LLD position. For example, in the inclined RLD position, the therapeutic cushion 100 can serve to minimize, or eliminate, gastro-esophageal reflux while it facilitates the emptying of the stomach into the duodenum. For example, in the inclined RLD position, the exit valve (i.e., the pyloric sphincter) of the user's stomach will be positioned substantially at a bottom right side of the user's abdomen below or at an elevation lower than an elevation of the user's esophageal sphincter. Thus, when the user remains in the inclined RLD position for a sufficient period of time, the stomach contents of the user can drain out of the stomach and into the duodenum. For example, a time period between about 1-4 hours may be needed to empty the contents of the stomach into the duodenum such that the user feels relief from symptoms associated with GERD and/or other digestive disorders. The time frame can vary depending on various factors such as for example, the user's overall health, other conditions the user may have such as diabetes, or gastroparesis, or the type and amount of food the user has consumed prior to resting on the cushion system, etc. In another example, in the inclined LLD position, a reduction in the frequency of reflux episodes of the user can result.

As also described above, the cushion 100 can be used during an endoscopy procedure to ensure the upper gastrointestinal tract is in alignment and to ease tube insertion. The patient can be positioned on a stretcher or procedure table on their left side with their head elevated. The elevated and left-side-down orientation allows the endoscope to slide down and into the stomach from the top and prevents pulmonary aspiration. Apparatus are described herein that can accommodate this position by inclining the patient between about 15-20° by supporting the torso and stabilizing the patient on their side on the apparatus. The patient's downside arm can be inserted into the receiving portion and the patient's back can lean against the back support 128 of the apparatus. The apparatus can be supported on an average endoscopy stretcher/table having a width of, e.g., about 26 inches. The receiving portion can be sized to accommodate a blood pressure cuff typically on the patient's downside arm.

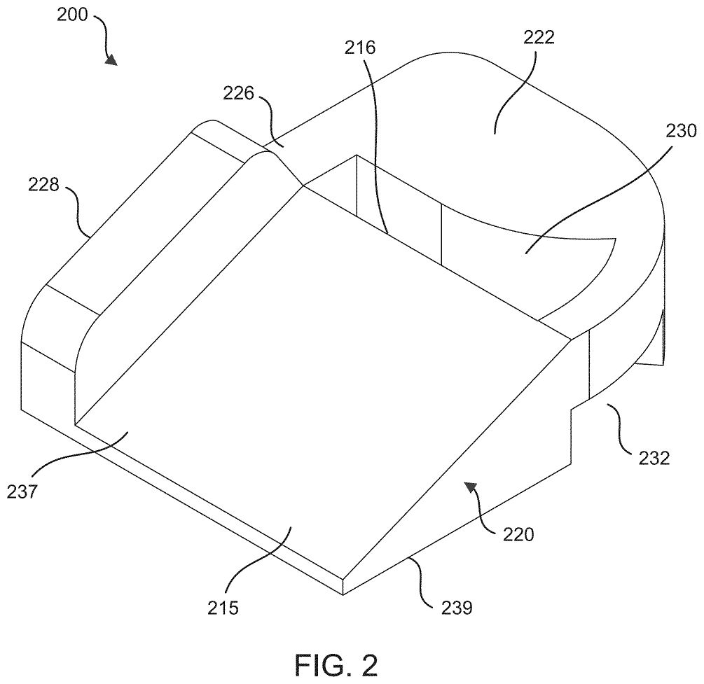

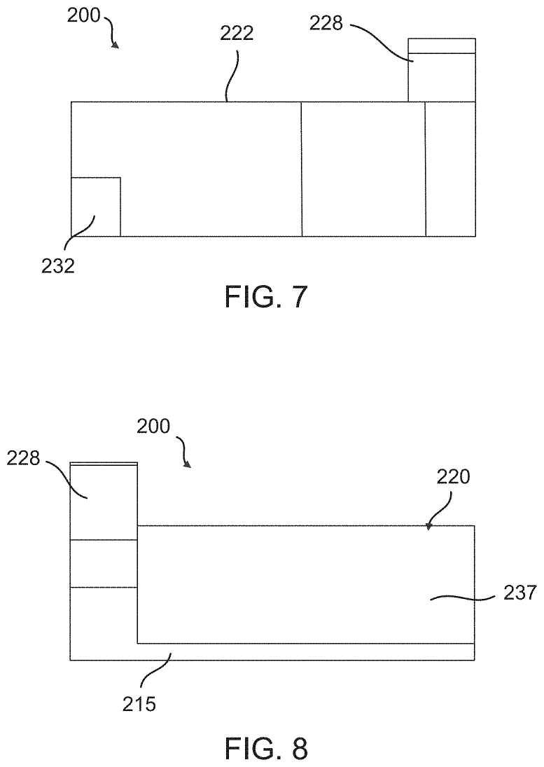

FIGS. 2-11 illustrate an embodiment of a therapeutic cushion. A therapeutic cushion 200 (also referred to herein as a “cushion” or “apparatus”) includes a body support portion 220 (also referred to herein as “wedge support” or “wedge portion” or “support portion”), a head support portion 222 (also referred to herein as “head support” or “head portion”) and a back support portion 228 (also referred to herein as a “back support”). As described above, the cushion 200 can be used as a method of treatment for GERD and/or other digestive disorders and during an endoscopy procedure to maintain a user/patient in a desired position and orientation during such procedures.

The body support portion 220, the head support portion 222 and the back support portion 228 can each be constructed the same as or similar to, and include the same or similar features, as the body support portion 120, the head support portion 122 and the back support portion 128, respectively, described above. Therefore, some details with respect to the materials and construction of the body support portion 220, the head support portion 222 and the back support portion 228 may not be described below.

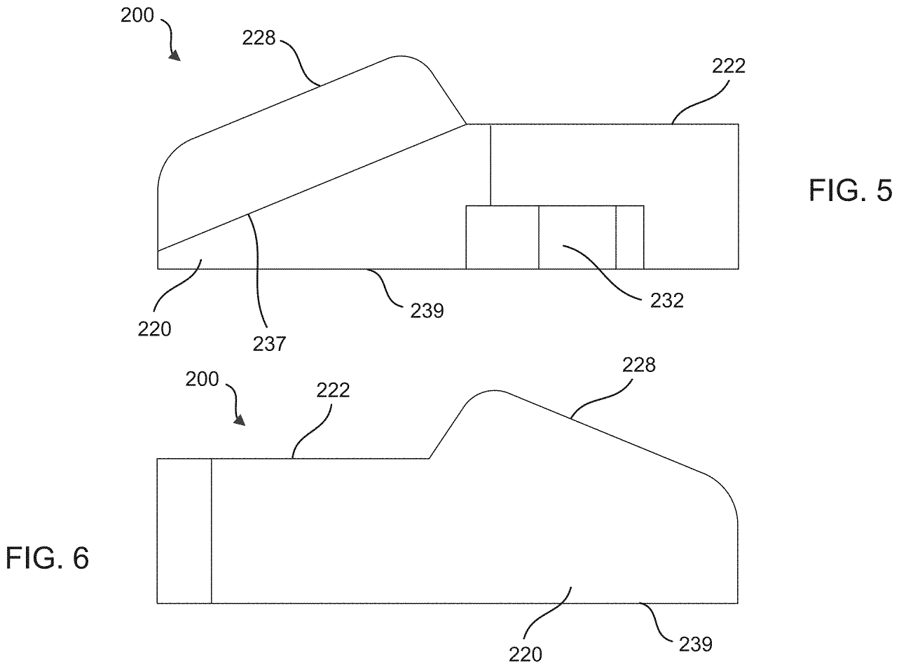

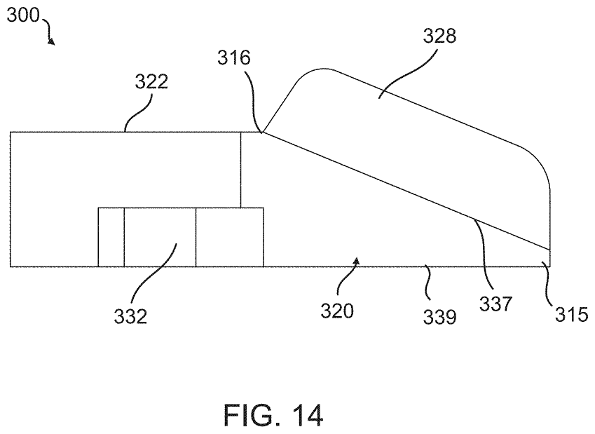

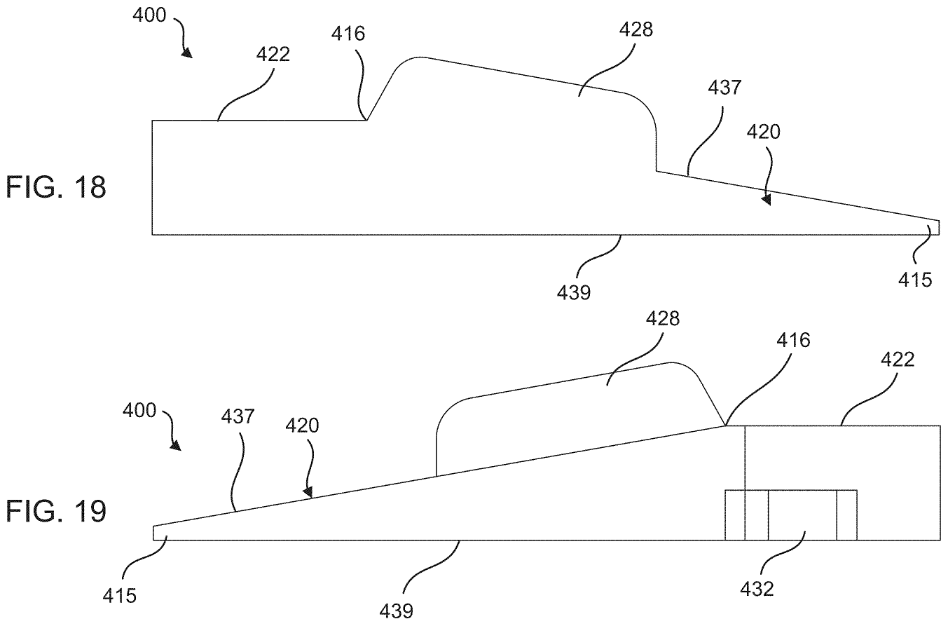

As with the previous embodiment, the body support portion 220 can be substantially wedge shaped and includes a top surface 237 that is angled relative to a bottom surface 239 (see, e.g., FIGS. 2 and 5) between a first end portion 215 and a second end portion 216 (see, e.g., FIG. 2). Said another way, the second end portion 216 has a height greater than the first end portion 215. In some embodiments, the angled top surface 237 can be disposed, for example, at an angle between 6 degrees and 30 degrees relative to the bottom surface 239 of the support portion 220. In this embodiment, the body support portion 220 can have a length, for example, between 10 and 30 inches and the overall therapeutic cushion 200 can have a length, for example, between 20 and 40 inches. Although the support portion 220 is shown with a particular length and width, in other embodiments, the support portion 220 can have a shorter or longer length (see, e.g., the embodiment of FIGS. 14-18) or be wider or narrower.

As with the previous embodiment, the head support portion 222 can be incorporated with the support portion 220 or can be fixedly or permanently coupled to the body support portion 220. The head support portion 222 is disposed near or proximate to the second end portion 216 of the body support portion 220 and can be used to support a neck and head of a user. A receiving portion 230 is defined between the head support portion 222 and the body support portion 220 that can receive a portion of a user's arm therein. The receiving portion 230 can be, for example, an opening, void, cavity, pocket, space or gap, etc. between the support portion 220 and the head support portion 222, in which a user can insert at least a portion of the user's arm. The receiving portion 230 can define a variety of different shapes when viewed, for example, from a top view, and can be symmetric or asymmetric. The body support portion 220 and the head support portion 222 can also collectively define a lower arm/elbow relief cavity (also referred to herein as “cavity” or “relief cavity”) 232, open to or in fluid communication with the receiving portion 230, which can receive a portion of a user's arm and/or hand therethrough. For example, when a user places an arm within the receiving portion 230, the user can extend a hand and/or a portion of the user's arm out through the relief cavity 232.

The back support portion 228 can be incorporated with the support portion 220 or can be fixedly or permanently coupled to the body support portion 220. In this embodiment, the back support portion 228 is disposed on the right side of the body support portion 220. During use of the cushion 200, a user can be disposed on the cushion on their left side and lean their back against the back support 228 to maintain the user in a side position.

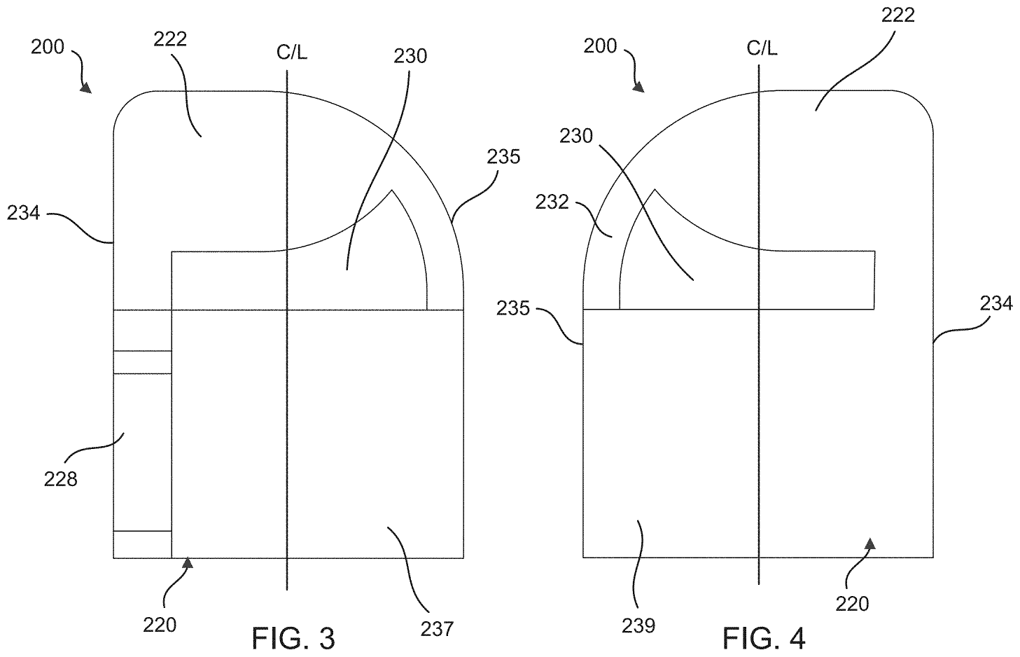

As best shown, for example, in the top and bottom views of FIGS. 3 and 4, respectively, the body support portion 220 and the head support portion 222 collectively define a shape of the therapeutic cushion 200 which includes a substantially linear first side edge 234 along a length of the therapeutic cushion 200 and an opposite second side edge 235 that includes a curved or radiused portion adjacent or proximate the head support portion 222. Thus, the overall shape of the cushion 200 is asymmetric. As shown in FIGS. 3 and 4, the receiving portion 230 extends from a centerline C/L of the cushion 200 outward asymmetrically in left and right lateral directions. In other words, the portion of the receiving portion 230 on the right side of the C/L of the cushion 200 (when viewed in the top view of FIG. 3) has a different shape and extent than the portion of the receiving portion 230 on the left side of the C/L of the cushion 200. Thus, when a user is disposed on the cushion on their left side with the user's left arm within the receiving portion 230 and their back against the back support 228, the receiving portion 230 on the right side of the cushion 200 provides additional space for the user's arm and/or shoulder.

As with the previous embodiment, the body support portion 220, the head support portion 222 and the back support 228 can each include a separate cushion member (not shown) coupled together or can be formed as a single cushion member. The cushion member(s) can be formed as described above for the previous embodiment. The cushion member(s) can be encased within a single outer casing 226. The outer casing 226 can be formed with one or more materials as described above for outer casing 126.

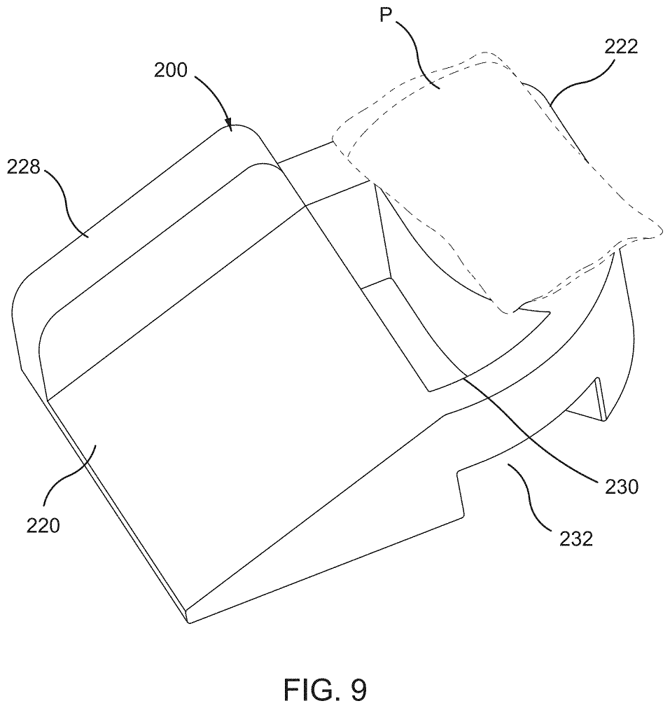

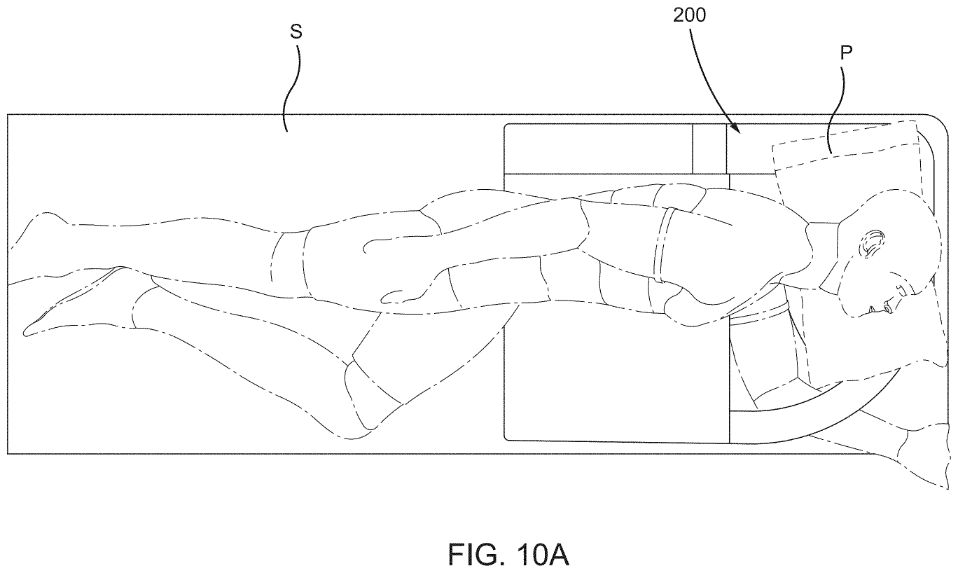

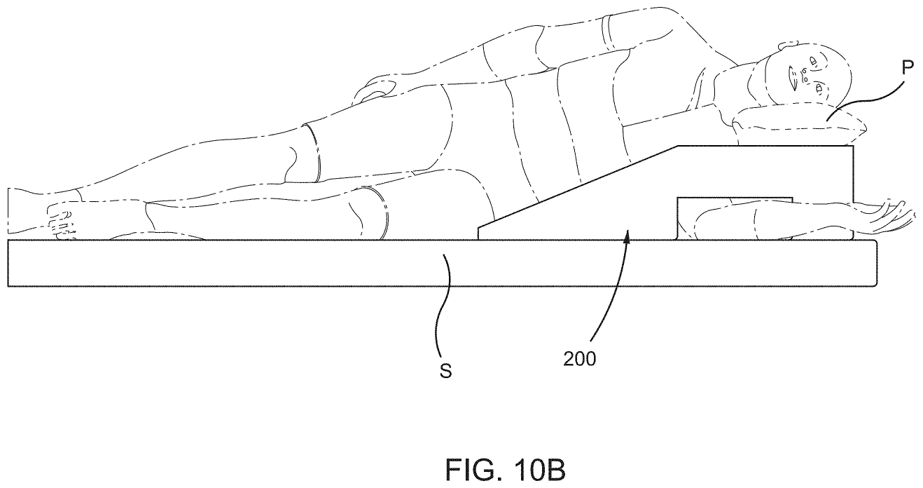

In use, the cushion 200 can be placed on a support surface S (e.g., a top surface of a bed or surgical table) and the user can then lie on the cushion 200 in a left side position with the user's head on the head support portion 222, as shown in FIGS. 10A and 10B. FIGS. 9-11 illustrate the cushion 200 being used with a pillow P disposed on the head support portion 222, but it should be understood that the pillow P is optional. The user's back can lean against the back support portion 228 to maintain the user in the side position. The user's arm and shoulder are inserted within the receiving portion and a portion of the user's arm and the user's hand are extended out through the cavity 232.

As described above, the cushion 200 can be used as a method of treatment for GERD and/or other digestive disorders and/or other medical conditions. To use the cushion 200 for this purpose, the user can follow the steps described above for being positioned on the cushion 200 in an inclined left side position.

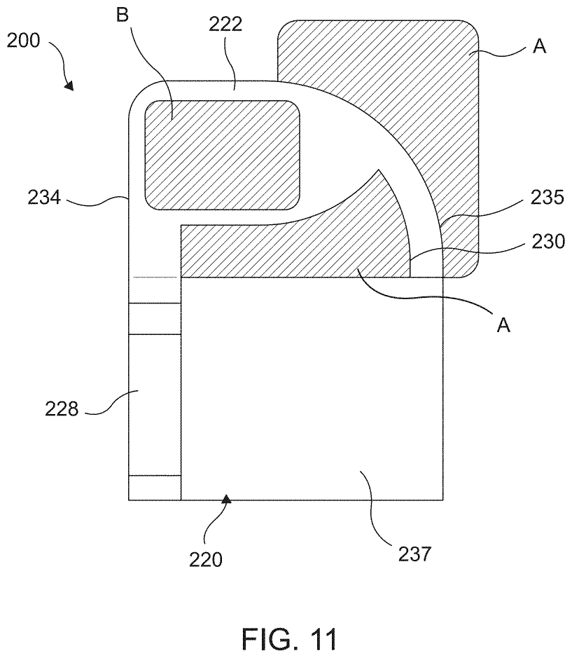

As also described above, the cushion 200 can be used during an endoscopy procedure to ensure the upper gastrointestinal tract is in alignment and to ease tube insertion. As shown in FIGS. 10A, 10B and 11, the asymmetric shape of the cushion 200 provides for additional surface area A on the underlying support surface S adjacent the curved side of the cushion 200, as shown, for example, in FIG. 11, such that the arm/hand of the user can be placed in varied positions and comfort for a procedure. Additionally, with one arm/hand disposed through the receiving portion 230 and cavity 232, both arms/hands are accessible for intravenous therapy or vitals monitoring. For example, the arm/hand extending through the cavity 232 can have a pressure monitoring, or other vitals monitoring device, attached thereto and accessible to a healthcare professional (e.g., physician, nurse, etc.). Further, an additional surface area B of the cushion 200 is provided in the straight, non-curved portion on the right hand side of the head support portion 222, as shown, for example, in FIG. 11, which allows a user's head to be arched or tilted backwards to straighten the user's throat/esophagus for a endoscopy procedure.

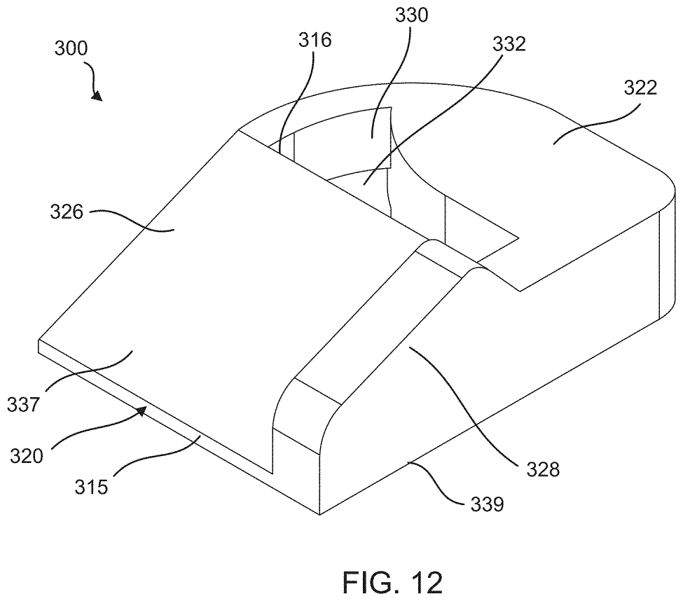

FIGS. 12-14 illustrate an embodiment of a therapeutic cushion 300 (also referred to herein as a “cushion” or “apparatus”) that can be constructed the same as or similar to the therapeutic cushions 100 or 200, and therefore some details may not be described with respect to cushion 300. It should be understood that the cushion 300 can include any of the features of cushions 200 and 100. The cushion 300 includes a body support portion 320 (also referred to herein as “wedge support” or “wedge portion” or “support portion”), a head support portion 322 (also referred to herein as “head support” or “head portion”) and a back support portion 328 (also referred to herein as a “back support”). As described above, the cushion 300 can be used as a method of treatment for GERD and/or other digestive disorders and/or other medical conditions.

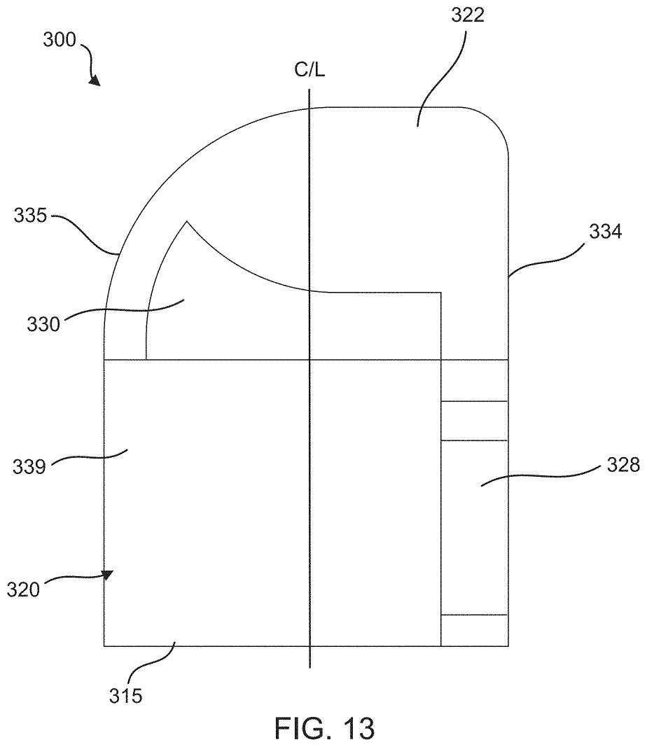

The body support portion 320, the head support portion 322 and the back support portion 328 can each be constructed the same as or similar to, and include the same or similar features, as described above for previous embodiments. As with the previous embodiment, the body support portion 320 can be substantially wedge shaped and includes a top surface 337 that is angled relative to a bottom surface 339 (see, e.g., FIGS. 13 and 14) between a first end portion 315 and a second end portion 316 (see, e.g., FIG. 13). Said another way, the second end portion 316 has a height greater than the first end portion 315. In some embodiments, the angled top surface 337 can be disposed, for example, at an angle between 6 degrees and 30 degrees relative to the bottom surface 339 of the support portion 320. In this embodiment, the body support portion 320 can have a length, for example, between 10 and 30 inches and the overall therapeutic cushion 300 can have a length, for example, between 20 and 40 inches. Although the support portion 320 is shown with a particular length and width, in other embodiments, the support portion 320 can have a different length and/or width.

As with the previous embodiment, the head support portion 322 can be incorporated with the support portion 320 or can be fixedly or permanently coupled to the body support portion 320. The head support portion 322 is disposed near or proximate to the second end portion 316 of the body support portion 320 and can be used to support a neck and head of a user. A receiving portion 330 is defined between the head support portion 322 and the body support portion 320 that can receive a portion of a user's arm therein. The receiving portion 330 can be, for example, an opening, void, cavity, pocket, space or gap, etc. between the support portion 320 and the head support portion 322, in which a user can insert at least a portion of the user's arm. The receiving portion 330 can define a variety of different shapes when viewed, for example, from a top view, and can be symmetric or asymmetric. The body support portion 320 and the head support portion 322 can also collectively define a lower arm/elbow relief cavity (also referred to herein as “cavity” or “relief cavity”) 332, open to or in fluid communication with the receiving portion 330, which can receive a portion of a user's arm and/or hand therethrough. For example, when a user places an arm within the receiving portion 330, the user can extend a hand and/or a portion of the user's arm out through the relief cavity 332.

The back support portion 328 can be incorporated with the support portion 320 or can be fixedly or permanently coupled to the body support portion 320. In this embodiment, the back support portion 328 is disposed on the right side of the body support portion 320 (e.g., as viewed from the top view of FIG. 13). During use of the cushion 300, a user can be disposed on the cushion on their right side and lean their back against the back support 328 to maintain the user in a side position.

As with the previous embodiment, and as best shown, for example, in the top view of FIG. 13, the body support portion 320 and the head support portion 322 collectively define a shape of the therapeutic cushion 300 which includes a substantially linear first side edge 334 along a length of the therapeutic cushion 300 and an opposite second side edge 335 that includes a curved or radiused portion adjacent or proximate the head support portion 322. Thus, the overall shape of the cushion 300 is asymmetric. As shown in the top view of FIG. 13, the receiving portion 330 extends from a centerline C/L of the cushion 300 outward asymmetrically in left and right lateral directions. In other words, the portion of the receiving portion 330 on the right side of the C/L of the cushion 300 (when viewed in the top view of FIG. 13) has a different shape and extent than the portion of the receiving portion 330 on the left side of the C/L of the cushion 300. Thus, when a user is disposed on the cushion on their right side with the user's right arm within the receiving portion 330 and their back against the back support 328, the receiving portion 330 on the left side of the cushion 300 provides additional space for the user's arm and/or shoulder.

As with the previous embodiment, the body support portion 320, the head support portion 322 and the back support 328 can each include a separate cushion member (not shown) coupled together or can be formed as a single cushion member. The cushion member(s) can be formed as described above for the previous embodiment. The cushion member(s) can be encased within a single outer casing 326. The outer casing 326 can be formed with one or more materials as described above for outer casing 126.

In use, the cushion 300 can be placed on a support surface (not shown) (e.g., a top surface of a bed or surgical table) and the user can then lie on the cushion 300 in a right side position with the user's head on the head support portion 322. An optional pillow can also be used as shown and described above for cushion 200. The user's back can lean against the back support portion 328 to maintain the user in the side position. The user's arm and shoulder can be inserted within the receiving portion 330 and a portion of the user's arm and the user's hand are extended out through the cavity 332.

As described above, the cushion 300 can be used as a method of treatment for GERD and/or other digestive disorders and/or other medical conditions. To use the cushion 300 for this purpose, the user can follow the steps described above for being positioned on the cushion 300 in an inclined right side position.

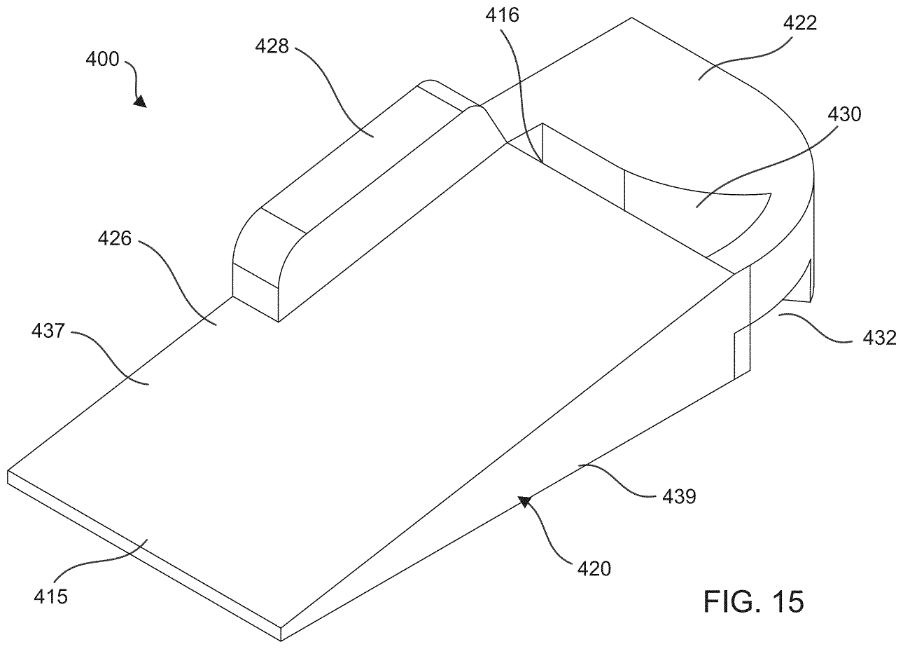

FIGS. 15-19 illustrate an embodiment of a therapeutic cushion 400 (also referred to herein as a “cushion” or “apparatus”) that can be constructed the same as or similar to the therapeutic cushions 100, 200 or 300, and therefore some details may not be described with respect to cushion 400. It should be understood that the cushion 400 can include any of the features of the cushions described above. The cushion 400 includes a body support portion 420 (also referred to herein as “wedge support” or “wedge portion” or “support portion”), a head support portion 422 (also referred to herein as “head support” or “head portion”) and a back support portion 428 (also referred to herein as a “back support”). As described above, the cushion 400 can be used as a method of treatment for GERD and/or other digestive disorders and/or during an endoscopy procedure to maintain a user/patient in a desired position and orientation during such procedures.

The body support portion 420, the head support portion 422 and the back support portion 428 can each be constructed the same as or similar to, and include the same or similar features, as described above for previous embodiments. As with the previous embodiment, the body support portion 420 can be substantially wedge shaped and includes a top surface 437 that is angled relative to a bottom surface 439 (see, e.g., FIGS. 15-17) between a first end portion 415 and a second end portion 416 (see, e.g., FIGS. 15-17). Said another way, the second end portion 416 has a height greater than the first end portion 415. In some embodiments, the angled top surface 437 can be disposed, for example, at an angle between 6 degrees and 30 degrees relative to the bottom surface 439 of the support portion 420. In this embodiment, the body support portion 420 and cushion 400 have a longer length than the body support portions 220, 320 and the therapeutic cushions 200, 300. For example, the body support portion 420 can have a length of, for example, between 10 and 50 inches and the overall therapeutic cushion 400 can have a length, for example, between 20 and 60 inches. Although the support portion 420 is shown with a particular length and width, in other embodiments, the support portion 420 can have a different length and/or width.

As with the previous embodiment, the head support portion 422 can be incorporated with the support portion 420 or can be fixedly or permanently coupled to the body support portion 420. The head support portion 422 is disposed near or proximate to the second end portion 416 of the body support portion 420 and can be used to support a neck and head of a user. A receiving portion 430 is defined between the head support portion 422 and the body support portion 420 that can receive a portion of a user's arm therein. The receiving portion 430 can be, for example, an opening, void, cavity, pocket, space or gap, etc. between the support portion 420 and the head support portion 422, in which a user can insert at least a portion of the user's arm. The receiving portion 430 can define a variety of different shapes when viewed, for example, from a top view, and can be symmetric or asymmetric. The body support portion 420 and the head support portion 422 can also collectively define a lower arm/elbow relief cavity (also referred to herein as “cavity” or “relief cavity”) 432, open to or in fluid communication with the receiving portion 430, which can receive a portion of a user's arm and/or hand therethrough. For example, when a user places an arm within the receiving portion 430, the user can extend a hand and/or a portion of the user's arm out through the relief cavity 432.

The back support portion 428 can be incorporated with the support portion 420 or can be fixedly or permanently coupled to the body support portion 420. In this embodiment, the back support portion 428 is disposed on the right side of the body support portion 420. During use of the cushion 400, a user can be disposed on the cushion on their left side and lean their back against the back support 428 to maintain the user in a side position.

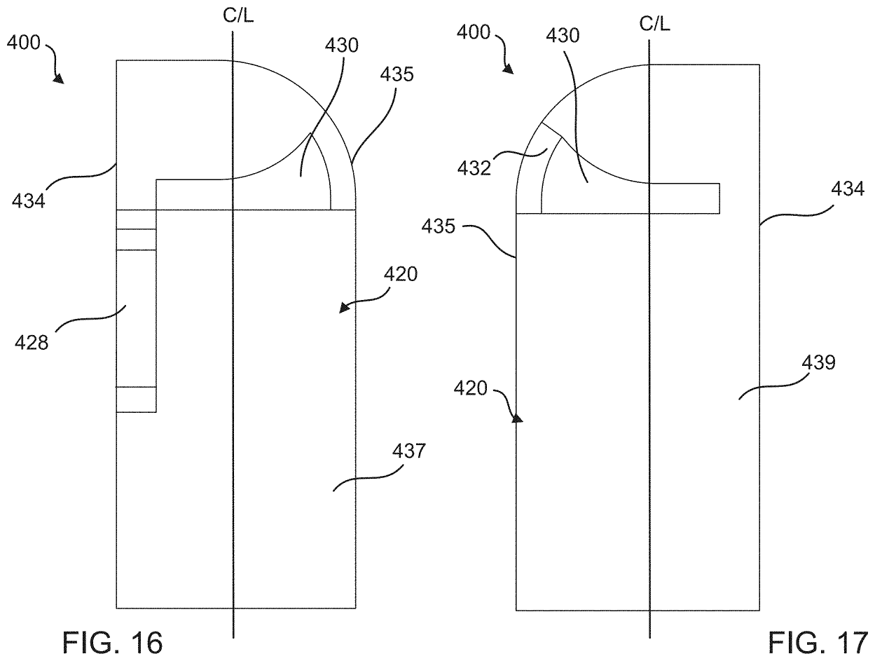

As with the previous embodiment, and as best shown, for example, in the top view and bottom view of FIGS. 16 and 17, respectively, the body support portion 420 and the head support portion 422 collectively define a shape of the therapeutic cushion 400 which includes a substantially linear first side edge 434 along a length of the therapeutic cushion 400 and an opposite second side edge 435 that includes a curved or radiused portion adjacent or proximate the head support portion 422. Thus, the overall shape of the cushion 400 is asymmetric. As shown, for example, in the top view of FIG. 16, the receiving portion 430 extends from a centerline C/L of the cushion 400 outward asymmetrically in left and right lateral directions. In other words, the portion of the receiving portion 430 on the right side of the C/L of the cushion 400 (when viewed in the top view FIG. 16) has a different shape and extent than the portion of the receiving portion 430 on the left side of the C/L of the cushion 400. Thus, when a user is disposed on the cushion 400 on their left side with the user's left arm within the receiving portion 430 and their back against the back support 428, the receiving portion 430 on the right side of the cushion 400 provides additional space for the user's arm and/or shoulder.

As with the previous embodiment, the body support portion 420, the head support portion 422 and the back support 428 can each include a separate cushion member (not shown) coupled together or can be formed as a single cushion member. The cushion member(s) can be formed as described above for the previous embodiment. The cushion member(s) can be encased within a single outer casing 426. The outer casing 426 can be formed with one or more materials as described above for outer casing 126.

In use, the cushion 400 can be placed on a support surface (not shown) (e.g., a top surface of a bed or surgical table) and the user can then lie on the cushion 400 in a left side position with the user's head on the head support portion 422. An optional pillow can also be used as shown and described above for cushion 200. The user's back can lean against the back support portion 428 to maintain the user in the side position. The user's arm and shoulder can be inserted within the receiving portion 430 and a portion of the user's arm and the user's hand are extended out through the cavity 432.

As described above, the cushion 400 can be used as a method of treatment for GERD and/or other digestive disorders and/or other medical conditions. To use the cushion 400 for this purpose, the user can follow the steps described above for being positioned on the cushion 400 in an inclined left side position. As also described above, the cushion 400 can be used during an endoscopy procedure to ensure the upper gastrointestinal tract is in alignment and to ease tube insertion.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above

Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

For example, as shown in the top view of FIG. 16, the cushion 400 includes a substantially sharp corner at the left side of the head support portion 422. It should be understood, however, that the top left corner of the cushion 400 can be rounded or radiused similar to head support portion 222. Similarly, the cushion 200 can include a substantially sharp corner at the top left corner of head support portion 222 and the cushion 300 can include a substantially sharp corner at the top right corner of head support portion 322.

In another example, a therapeutic cushion can be constructed the same as or similar to the cushion 400, except the back support portion 428 is disposed on the opposite side of the body support portion 420 similar to therapeutic cushion 300. In some alternative embodiments, a therapeutic cushion may not include an elbow relief cavity (e.g., 232, 332, 432) and/or a back support portion (e.g., 128, 228, 328, 428) and/or a receiving portion (e.g., 230, 330, 430).

What is claimed is:

1. A method, comprising:
disposing a cushion on a support surface, the cushion including a body support portion, a head support portion and a back support portion, the body support portion and the head support portion collectively defining a receiving portion configured to receive at least a portion of a user's arm therein, the back support disposed on a portion of the top surface of the body support portion and configured to maintain the user in a side position on the cushion;
instructing a user to lie on the cushion in a side position with at least a portion of the user's arm disposed in the receiving portion and the user's back disposed against the back support portion or placing the user on the cushion in a side position with at least the portion of the user's arm disposed in the receiving portion and the user's back disposed against the back support portion; and
after the user is positioned on the cushion in the side position, performing an endoscopy procedure on the user.

2. The method of claim 1, wherein the disposing the cushion on the support surface includes disposing the cushion on a top surface of a surgical table.

3. The method of claim 1, wherein the cushion defines a relief cavity in fluid communication with the receiving portion, the method further comprising:
instructing the user to place the user's hand at least partially through the relief cavity of the cushion or placing the user's hand at least partially through the relief cavity of the cushion.

4. The method of claim 3, wherein the receiving portion includes a first portion on a first side of a centerline of the cushion and a second portion on an opposite, second side of the centerline of the cushion, the first portion having an interior volume greater than the second portion, the relief cavity being disposed proximate the first portion of the receiving portion.

5. The method of claim 1, wherein the receiving portion is asymmetric relative to a centerline of the cushion.

6. The method of claim 1, wherein a perimeter of the receiving portion is bounded entirely by at least a portion of the body support portion and a portion of the head support portion.

7. The method of claim 1, wherein the cushion has an asymmetric shape in a top view and includes a first side edge and a second side edge opposite the first side edge, the first side edge being substantially linear and extending along the body support portion and the head support portion, the second side edge includes a curved portion at the head support portion,
the curved shape of the second side edge providing access to the user for intravenous therapy or vitals monitoring during the endoscopy procedure.

8. The method of claim 7, wherein the head support portion has a greater surface area near the first side edge than a surface area near the second side edge to provide a greater space to accommodate the user's head on the head support when the user is disposed on the cushion in the side position.

9. The method of claim 1, wherein the side position of the user provides for alignment of an upper gastrointestinal tract for tube insertion.

10. A method, comprising:
disposing a cushion on a support surface, the cushion including a body support portion, a head support portion and a back support portion, the body support portion and the head support portion collectively defining a receiving portion configured to receive at least a portion of a patient's arm therein, the back support disposed on a portion of the top surface of the body support portion and configured to maintain the user in a side position on the cushion, the cushion having an asymmetric shape in a top view and includes a first side edge and a second side edge opposite the first side edge, the first side edge being substantially linear and extending along the body support portion and the head support portion, the second side edge includes a curved portion at the head support portion;
positioning the patient in a side position with at least a portion of the patient's arm disposed in the receiving portion and the patient's back disposed against the back support portion, the side position of the patient providing for alignment of an upper gastrointestinal tract for tube insertion; and
after the patient is positioned on the cushion in the side position, performing an endoscopy procedure on the patient, the curved shape of the second side edge providing access to the patient for intravenous therapy or vitals monitoring during the endoscopy procedure.

11. The method of claim 10, wherein the disposing a cushion on a support surface includes disposing the cushion on a top surface of a surgical table.

12. The method of claim 10, wherein the cushion defines a relief cavity in fluid communication with the receiving portion, the method further comprising:
placing the patient's hand at least partially through the relief cavity of the cushion.

13. The method of claim 10, wherein a perimeter of the receiving portion is bounded entirely by at least a portion of the body support portion and a portion of the head support portion.

14. The method of claim 10, wherein the head support portion has a greater surface area near the first side edge than a surface area near the second side edge to provide a greater space to accommodate the patient's head on the head support when the patient is disposed on the cushion in the side position.

15. A method, comprising:
disposing a cushion on a support surface, the cushion including a body support portion, a head support portion and a back support portion, the body support portion and the head support portion collectively defining a receiving portion configured to receive at least a portion of a patient's arm therein, the back support disposed on a portion of the top surface of the body support portion and configured to maintain the user in a side position on the cushion, the cushion having an asymmetric shape in a top view and includes a first side edge and a second side edge opposite the first side edge, the first side edge being substantially linear and extending along the body support portion and the head support portion, the second side edge includes a curved portion at the head support portion;
instructing the patient to lie on the cushion in a side position with at least a portion of the patient's arm disposed in the receiving portion and the patient's back disposed against the back support portion, the side position of the patient providing for alignment of an upper gastrointestinal tract for tube insertion; and
after the patient is positioned on the cushion in the side position, performing an endoscopy procedure on the patient, the curved shape of the second side edge providing access to the patient for intravenous therapy or vitals monitoring during the endoscopy procedure.

16. The method of claim 15, wherein the disposing a cushion on a support surface includes disposing the cushion on a top surface of a surgical table.

17. The method of claim 15, wherein the cushion defines a relief cavity in fluid communication with the receiving portion, the method further comprising:
instructing the patient to place the patient's hand at least partially through the relief cavity of the cushion.

18. The method of claim 15, wherein a perimeter of the receiving portion is bounded entirely by at least a portion of the body support portion and a portion of the head support portion.

19. The method of claim 15, wherein the head support portion has a greater surface area near the first side edge than a surface area near the second side edge to provide a greater space to accommodate the patient's head on the head support when the patient is disposed on the cushion in the side position.
